(19) United States
(12) Patent Application Publication
(10) Pub. No.: US 2010/0324995 A1
(43) Pub. Date: Dec. 23, 2010

(54) Method and System for Content Delivery using Delivery Report Message

(76) Inventors: Colm Ward, Limerick (IE); Kieran Kelly, Limerick (IE); Kay Mulqueen, Kilmurry (IE); David Mullen, Ennis (IE)

Correspondence Address: BOHAN MATHERS, PO BOX 17707, PORTLAND, ME, 04112-8707, US

(21) Appl. No.: 12/867,664

(22) PCT Filed: Feb. 17, 2009
(86) PCT No.: PCT/EP09/01131

§ 371 Date: Aug. 13, 2010

(30) Foreign Application Priority Data
Feb. 19, 2008 (IE) S2008-0126

(51) Int. Cl. H04W 4/12; G06Q 30/00

(52) U.S. Cl. 705/14.64; 455/412.1; 455/466

(57) ABSTRACT

The present invention relates to a data messaging system and method for transmitting content to a subscriber of telephony services which are provided by an operator, such as a mobile network operator. The method and system facilitates the transmission of content in a delivery report message sent to the subscriber device from a messaging centre. Such a system and method enables the use of the status/delivery report message mechanism associated with a data messaging services as a backwards communication channel.

### BACKGROUND INFORMATION

1. Field of the Invention

The present invention relates to a data messaging system and method.

2. Description of the Prior Art

Data messaging services are provided to subscribers of cellular wireless networks of various types (such as GSM, 3G and CDMA) by Messaging Centres usually located in the network of the message originator. Such Messaging Centres receive the message, possibly store it temporarily, and deliver it to the intended destination as specified by the originator. The capabilities required of the subscriber's Wireless Devices and of the various types of networks to enable this data messaging are specified in detail by the appropriate standardisation bodies (for example, the 3GPP and 3GPP2 set of specifications and earlier specifications from ITUT, ETSI and ANSI amongst others). In general, these standards apply for both Short Message Service (SMS) and Multimedia Message Service (MMS) data messaging services. Messaging Centres typically conforming to standards have been developed by a wide variety of vendors and deployed with network operators globally to implement store and forward and related functionality for data messaging.

In more recent years, as wireless networks, network coverage and wireless devices have advanced, and subscriber behaviour has changed, wireless devices are much more constantly contactable. Traffic (particularly SMS traffic) has also increased dramatically. In this context, much of the data messaging traffic can be delivered immediately, and many of the Messaging Centre functions have been devolved and incorporated into distributed Message Routers, which may also have store and forward functions and which show some advantages over conventional Messaging Centres, For the purposes of the following description, the term Messaging Centre will be understood to cover both conventional Messaging Centres as well as Message Routers.

Messaging centres are known to return a Status Report (SR) for SMS, sometimes also called a delivery report (DR) message, for MMS, to the originator device, which provides an update on the progress of the message, typically giving the time at which the message was delivered to the destination, and in some cases optionally, when the message was read by the destination party (Read Report). For the purposes of the following description, the term delivery report message will be understood to cover any such types of report message sent to the originator, for SMS or MMS services, in GSM/3G or 4G or CDMA or other wireless networks.

The percentage of subscribers who request delivery report messages varies from operator to operator, but it can be as high 60-70% for SMS messages and represents a substantial processing overhead for the wireless network, using valuable network resources which would otherwise be available to carry additional revenue earning data messages. The overhead for delivery report messages in SMS messaging services is typically approximately 66% capacity over that required for the delivery of the original message. The actual value of the delivery report messages for the subscriber is also questionable, since most modern networks achieve reliable first time delivery of approximately 70% of the SMS traffic. MMS traffic is much lower in even the most advanced networks, however the same problems apply; the delivery report message uses valuable network capacity without providing any revenue for the operator and is of questionable value to the recipient.

In many modern wireless cellular networks, the majority of the subscriber base choose “Prepaid” accounts, in which no bills are issued, with the consequence that there may not be an address or even a name associated with the account. Apart from general broadcast media, the operator's sole means of communicating with many of its subscribers may be by means of the wireless device. Undoubtedly, even where other means are possible, the wireless device is the most cost effective and convenient communication channel for the operator. However, it is increasingly common that unsolicited communication from the network operator is resented by the subscribers and in some cases may be subject to control by regulatory authorities, creating a problem for operators. In many cases the take-up of new products and services is limited by the operator's inability to make their subscribers aware of the products or services or to promote them effectively.

For example, it is also well known that data content services may be provided to cellular subscribers as a means of enhancing the user's experience and of earning additional revenue for the operator or service provided. Examples of such content services are sport, entertainment, weather, news, etc. Generally such services are provided on an opt-in basis, where the subscriber requests the service by sending a request message to a special network address which is routed to a specialised content server. The content server stores the users requested preference and provides the information, either on a regular or asynchronous basis (so called “Push” services) or following further requests (“Pull” services) etc. Most content is provided in current networks using “Push” type delivery, which can be very intrusive for the recipient and whose delivery success rates can be very low.

The service subscriber may be charged once-off on subscription, on a periodic subscription basis, or on the basis of the information delivered, or using a combination of all of these. Charging may be in real time, from a prepaid account, or may be by periodic billing, or other payment methods, as is well known. It is also well known that provision of any content to a mobile subscriber by a number of means may include the provision of embedded “links” by which means the subscriber can access and “browse” further content.

Sponsored services to wireless cellular users, where some or all of a standard network service, such as voice calls, data messaging, content services, internet access and the like, may also be provided free of charge or on a subsidised basis to the subscriber. Subscribers accepting such sponsored services must generally accept sponsorship messages or advertising before or during their use of the service. The network operator or service provider thereby receives an additional revenue stream from the sponsors. Sponsorship as applied to voice services, traditionally involves a calling party listening to a pre-call announcement, following which the normal requested call proceeds, possibly part subsidised by the sponsor. This type of sponsored call is specifically supported by the widely deployed IN/CAMEL standards. For data services, particularly for SMS and MMS messaging, there are no specific standards related to provision of sponsored services. Sponsoring of these services, for person to person messaging, has tended to be implemented by appending sponsor's messages to the initial message originated by the sender. This can be very annoying for the recipient, who has no choice in the matter, and can also be off-putting for the sender, who may not wish the recipient to know they are availing of a sponsored service. This implementation problem may be inhibiting the growth of sponsored messaging services and thereby inhibiting the growth of data messaging services for a segment of the market.

It is a therefore an object of the present invention to provide a messaging system and method which goes at least some way toward overcoming the above problems and/or which will provide the public and/or industry with a useful alternative.

### BRIEF SUMMARY OF THE INVENTION

It is acknowledged that the term ‘comprise’ may, under varying jurisdictions be provided with either an exclusive or inclusive meaning. For the purpose of this specification, and unless otherwise noted explicitly, the term comprise shall have an inclusive meaning—i.e. that it may be taken to mean an inclusion of not only the listed components it directly references, but also other non-specified components. Accordingly, the term ‘comprise’ is to be attributed with as broader interpretation as possible within any given jurisdiction and this rationale should also be used when the terms ‘comprised’ and/or ‘comprising’ are used.

Further aspects of the present invention will become apparent from the ensuing description which is given by way of example only.

According to the invention, there is provided a method of transmitting content to a subscriber of telephony services provided by an operator, the method comprising the steps of:
generating a delivery report message;
retrieving content to be sent to the subscriber, and
transmitting the retrieved content with the delivery report message to the subscriber.

Such a method enables the use of a status/delivery report message mechanism associated with a data message service as a backward communication channel with the subscriber, thereby enabling useful content, including advertising messages, to be returned with the delivery report message. This will enable the operator to charge for the content service, and also optionally to charge sponsors for transmitting their messages to the subscribers. In this way the delivery report mechanism is transformed from a relatively redundant feature and a significant network overhead into a valuable communications channel.

In another embodiment of the invention, the steps of the method are performed only if the subscriber has requested a delivery report message be sent by the messaging centre.

In another embodiment of the invention, the method comprises a step of embedding the retrieved content in the delivery report message for transmission to the subscriber device.

In another embodiment of the invention, the method comprises a step of generating a further data message, whereby the retrieved content is embedded in the further data message for transmission to the subscriber at substantially the same time as the delivery report message.

Optionally this additional message may be one of a number of different types, according to the relevant standards, which includes the use of a “Flash” message which is displayed on the screen of the wireless device and must be acknowledged by the subscriber, but otherwise is not stored on the subscriber device.

Preferably, the data messages and/or delivery report message are transmitted in short message service (SMS), multi-media message service (MMS), electronic mail (e-mail) and/or instant message format.

In another embodiment of the invention, the data messages and/or delivery report message are transmitted via a wireless cellular network, wherein the cellular network is one of a GSM network; a 3G or 4G network, and a CDMA network.

In another embodiment of the invention, the method comprises a step of retrieving the content from a storage means coupled locally with a messaging centre.

Alternatively or additionally, the content is retrieved from one or more content servers connected remotely to the messaging centre.

In a further embodiment the method comprises a step of retrieving the content from a content queue for the subscriber. Such a feature enables the present invention to interwork with legacy “push” based content provision platforms. In this way the content is delivered at a time of the subscribers choosing, avoiding the annoyance which can be associated with asynchronous content broadcast. Similarly, the content is delivered at a time when the status of the wireless device is know, providing much higher delivery success rates than conventional “push” type delivery.

In another embodiment of the invention, the method comprises a step of personalising the retrieved content prior to transmission with the delivery report message.

Preferably, the content retrieved is personalised according to one or more of: a location of the subscriber device in a telecommunications network, spend attributes of the subscriber and preferences set by the subscriber and/or the mobile network operator. The messaging centre, which is aware of the location of the originating subscriber within the mobile network, may thus cause the content or advertising supplied to be specific to the location of the originating subscriber. Optionally, the content retrieved is personalised according to spend attributes of the subscriber.

In another embodiment of the invention, the method comprises a step of storing subscriber preferences locally in a messaging centre and/or in one or more subscriber profile servers connected remotely to a messaging centre.

In another embodiment of the invention, the method comprises a step of determining whether the subscriber device has opted in or opted out of receiving the content with the delivery report message.

In another embodiment of the invention, the method comprises a step of time-stamping the retrieved content sent with the report message according to when the delivery report message is sent.

In another embodiment of the invention, the retrieved content sent with the report message includes an advertising message and/or sponsorship information.

In another embodiment of the invention, the method comprises a step of rotating the advertising and/or sponsorship information through a sequence so that content sent to the subscriber with two or more consecutive delivery report messages is not the same. This feature ensures that the same content/advertising is not repeatedly sent to the same subscriber.

In another embodiment of the invention, the retrieved content sent with the report message comprises interactive links which are able to be selected by the subscriber to trigger the transmission of interactive content to the subscriber.

In another embodiment of the invention, the content is provided by receiving standard delivery reports from an otherwise unmodified messaging centre and amending the contents of the delivery report actually sent to the subscriber by inserting/appending the content and modifying other fields appropriately.

According to a further aspect of the invention, there is provided a system for transmitting content to a subscriber of telephony services provided by an operator comprising:

means for generating a delivery report message;

means for retrieving content to be sent to the subscriber device, and

means for transmitting the retrieved content with the delivery report message to the subscriber.

In another embodiment of the invention, the system comprises means for embedding the retrieved content in the delivery report message for transmission to the subscriber device.

In another embodiment of the invention, the system comprises means for generating a further data message and embedding the retrieved content in the further data message for transmission to the subscriber at substantially the same time as the delivery report message.

Preferably, the further data message is displayed on a display screen of a subscriber device and is not stored in a memory of the subscriber device.

In another embodiment of the invention, the system comprises means for retrieving the content from a storage means coupled locally with a messaging centre.

In another embodiment of the invention, the system comprises means for retrieving the content from one or more content servers connected remotely to a messaging centre.

In another embodiment of the invention, the system comprises means for generating a content queue for a subscriber and retrieving the content from the content queue for transmission with the delivery report message.

In another embodiment of the invention, the system comprises means for personalising the retrieved content prior to transmission with the delivery report message.

In another embodiment of the invention, the system comprises means for personalising the content according to one or more of: a location of the subscriber device in a telecommunications network, spend attributes of the subscriber and preferences set by the subscriber and/or the mobile network operator.

In another embodiment of the invention, the system comprises means for storing subscriber preferences locally in a messaging centre and/or in one or more subscriber profile servers connected remotely to a messaging centre.

In another embodiment of the invention, the system comprises means for determining whether the subscriber device has opted in or opted out of receiving the content with the delivery report message.

In another embodiment of the invention, the system comprises means for time-stamping the retrieved content sent with the report message according to when the delivery report message is sent.

In another embodiment of the invention, the system comprises means for rotating the advertising and/or sponsorship information through a sequence so that content sent to the subscriber with two or more consecutive delivery report messages is not the same.

In another embodiment of the invention, the system comprises means for providing content by receiving standard delivery reports from an otherwise unmodified messaging centre and amending the contents of the delivery report actually sent to the subscriber by inserting or appending the content and modifying other fields of the message.

### BRIEF DESCRIPTION OF THE DRAWINGS

The invention will be more clearly understood from the following description of some embodiments thereof, given by way of example only, with reference to the accompanying drawings, in which;

FIG. 1 is a stylised schematic showing a prior art messaging centre in a wireless cellular network;

FIG. 2 is a stylised schematic showing a further prior art messaging centre in a wireless cellular network;

FIG. 3 is a stylised schematic showing a messaging centre in a wireless cellular network configured in accordance with the present invention;

FIG. 4 is a stylised schematic showing a messaging centre in a wireless cellular network configured according to an alternative embodiment of the present invention;

FIG. 5 is a stylised schematic showing a standard messaging centre in a wireless cellular network configured according to an alternative embodiment of the present invention;

FIG. 6 is a message flow diagram showing the message exchanges in a network configured according to FIG. 3, and

FIG. 7 is the first half of a diagram illustrating the steps in a method performed according to the present invention.

FIG. 8 is the second half of he diagram illustrating the method steps.

### DETAILED DESCRIPTION OF THE INVENTION

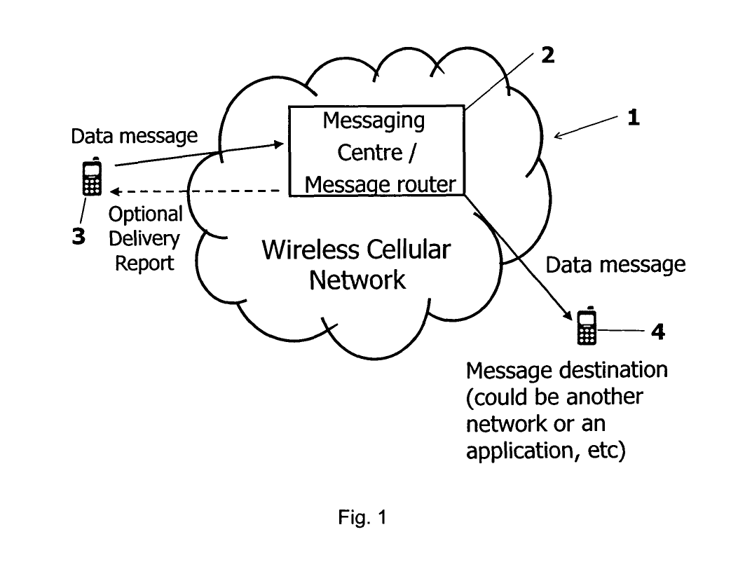

Referring to the drawings, and initially to FIG. 1, there is shown a wireless cellular network, indicated generally by the reference numeral 1, and a messaging centre (or message router) 2. Also shown is a message originator device 3 and a message destination device 4 which are contactable by the messaging centre 2 in the network 1. In general, a subscriber account associated with the originator device 3 from which a message is sent is charged for sending the message, although in some cases a subscriber account associated with the destination 4 may also be charged. It will be understood that such subscriber accounts are provided by an operator providing mobile telephony services.

FIG. 1 shows a data message being sent from the message originator device 3, which in the instance shown is a mobile telephone. It will however be understood that the message originator device 3 need not be a mobile telephone, but may alternatively be any suitable device capable of performing a messaging function and capable of availing of various subscriber type services provided by an operator. Such a device 3, 4 may thus be PDA, BlackBerry or any other suitable device.

The data message sent is received by the messaging centre 2 which subsequently forwards the message to the destination device 4. FIG. 1 also shows the optional return of a delivery report message to the originator device 3. The option to request a delivery report message is specified by the originator device 3, usually by a selected general preference stored in the originator device 3. As implemented in most wireless cellular systems worldwide, this delivery report service is provide free of charge by the network operator or service provider.

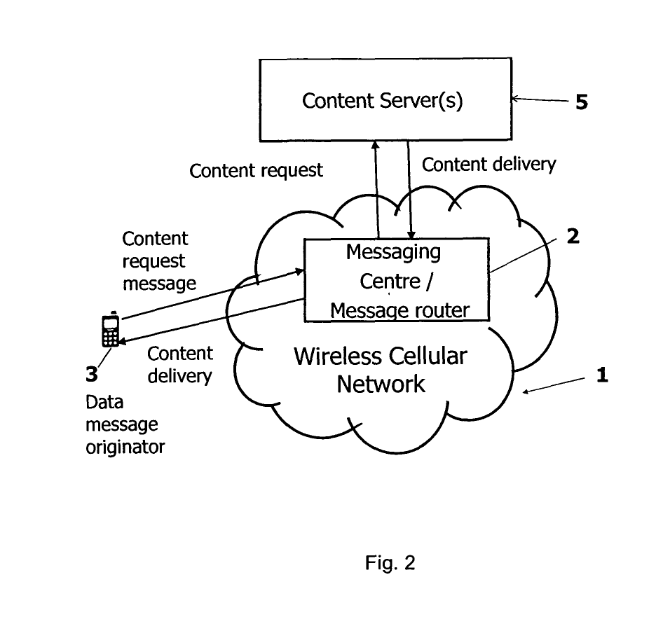

FIG. 2 shows an arrangement facilitating the request for and delivery of content to the originator device 3. In the instance shown, the Messaging Centre 2 forwards the content request to a content server 5 which provides the content via this or another Messaging Centre to subscribers, either on request (as shown) or on a periodic or autonomous basis.

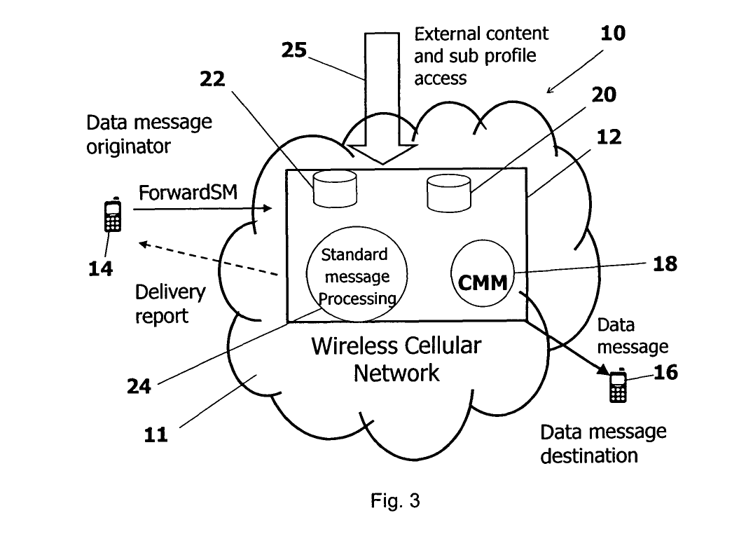

FIG. 3 shows a messaging system 10 operable in a wireless cellular network 11 the system 10 comprising a messaging centre 12 configured for use in accordance with the present invention. The messaging system 10 is adapted for transmitting content in or with a delivery report message sent by the messaging centre 12 to a subscriber of services provided by an operator. The delivery report message sent by the messaging centre 12 is in response to an attempt by the subscriber to send an initial data message to a destination device 16. The content transmitted with the report message can be inserted in the delivery report message or may be inserted in a further data message sent with the delivery report message. Such content transmitted with the delivery report message may be an advertisement or sponsorship information or comprise interactive links which are able to be selected to provide interactive content to the subscriber. The advertising messages and/or sponsorship information may be rotated through a sequence of possible messages, so that the same subscriber is not exposed to two or more consecutive messages which are the same.

It will be understood that in the instance shown the subscriber is also represented by the message originator or subscriber device 14 and in practice, the cellular network 11 could be a GSM, 3G. 4G or CDMA network, while the data messaging could be according to a number of standard formats, including but not limited to SMS, MMS, email, instant messaging and other data messaging standards which include a delivery report or similar mechanism.

In the instance shown, the Messaging Centre 12 further comprises content processing logic 18, an optional content store 20 coupled locally with the messaging centre 12, and an optional means 22 for storing subscriber preference. In addition, an optional means of external access 25 for modifying and/or adding new content or subscriber preferences is shown. The standard message processing of the messaging centre 12 is performed by a central controller 24 which also comprises the means for retrieving content, via the content processing logic 18, for transmitting in or with the report message, and means for sending the retrieved content in or with the report message to the subscriber device 14. The central controller 24 determines if the subscriber has, via the subscriber device 14, requested that a delivery report message is to be sent by the messaging centre 12, and is adapted so as to determine, via the content processing logic 18, whether the subscriber 14 has “opted-out” or “opted-in” to the service. The standard message processing of the central controller 24 has thus been modified so that when it is preparing to send a delivery message report to a subscriber 14 it first determines if the subscriber has “opted-out/in” of the advertising/content service, then retrieves one or more items of content from the internally maintained content store 20, includes the content to the message report to be sent to the subscriber 14 and then sends the report message to the subscriber 14. The retrieved content sent with the delivery report message may also be time-stamped according to the delivery time of the sent message.

The content Store 20, as shown in FIG. 3, includes the capability of storing queued content destined for the subscriber from “push” type broadcast content servers. The content Store 20 is similar in structure to the conventional queue maintained for outgoing messages, except that the items are queued by the originator rather than the recipient, and that the parameters (validity period, retry algorithms and intervals, etc.) associated with each item are optimised for the content delivery application,

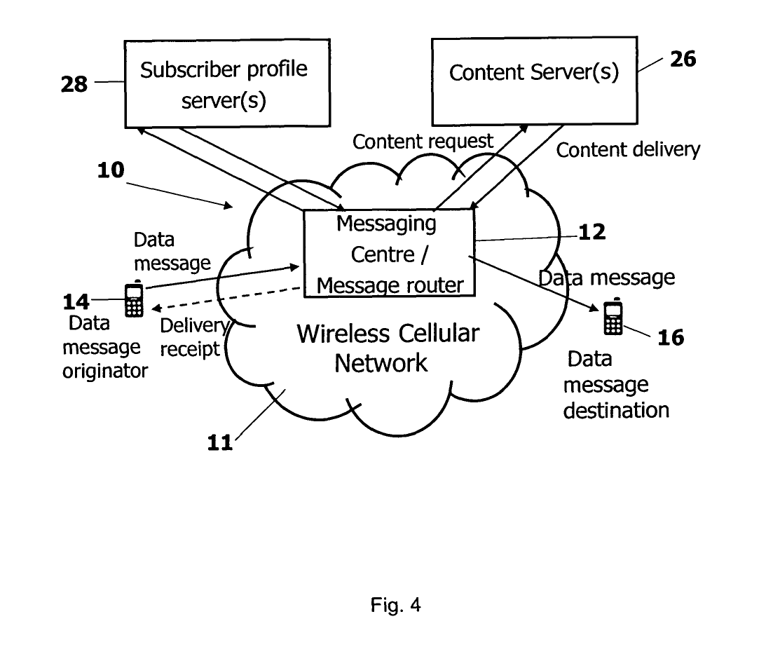

As shown in FIG. 4, the messaging system 10 may comprise one or more content servers 26 which are connected remotely to the messaging centre 12, the content being retrieved from the one or more content servers 26. The messaging system 10 shown also comprises one or more subscriber profile servers 28 connected remotely to the messaging centre 12, the subscriber profile server(s) 28 storing subscriber preferences which facilitate personalisation of the content included with the delivery report message. Each subscriber 14 may set preferences according to which the content retrieved is personalised. The content may also be personalised by means of a query made to the subscriber profile server(s) 28. The personalisation of content may also be carried out according to the subscriber's own choices, or to attributes of the subscriber allocated or calculated by the network operator, such as total monthly spend or other attributes of the subscriber. Furthermore, the content retrieved may be personalised according to the location of the subscriber in the network 11.

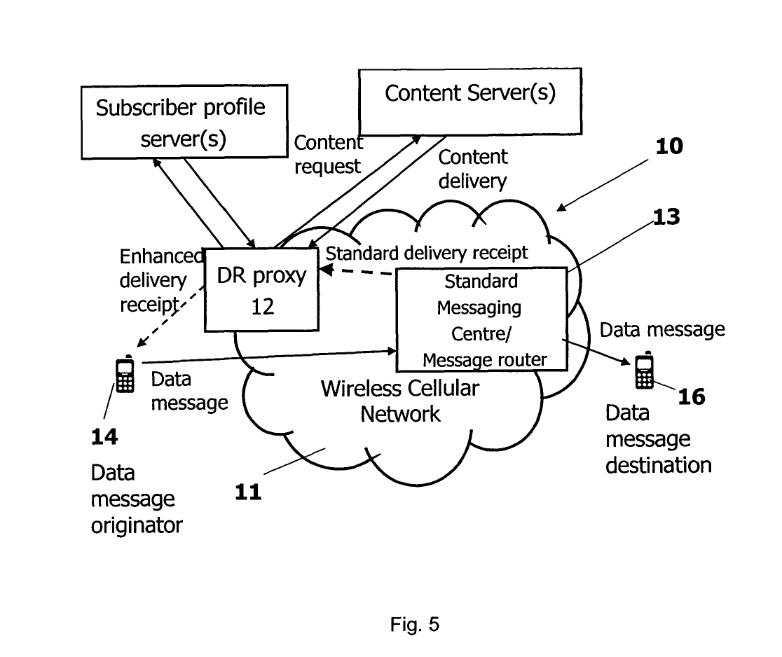

FIG. 5 shows an alternative embodiment of the invention in which the advantages of the invention can be provided with an otherwise unmodified messaging centre 13. In this embodiment the routing tables in the messaging centre or an associated network element are modified in such a way as to route the standard delivery reports to a specially inserted network element 12 which acts as a “delivery report” proxy and implements the remaining aspects of the invention as described. In this embodiment additional capabilities are able to be provided in an “add on” manner in accordance with the present invention. Functionally, the invention acts as a “delivery report proxy” in this configuration, receiving a standard delivery report and sending a modified and enhanced delivery report bearing the appropriate content. The present invention thus also provides a system and a method which is adaptable and can achieve the advantages of the present invention in circumstances in which an existing messaging system is unable or not easily or not affordably able to be upgraded or replaced but must remain in service.

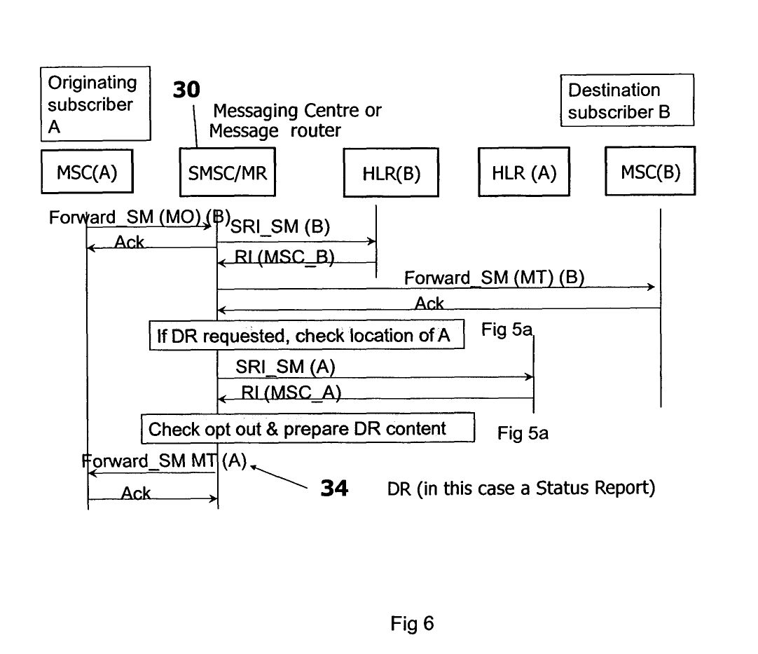

FIG. 6 is a message flow diagram showing message exchanges in a network configured according to FIG. 3, and illustrates the case of SMS messages in a GSM or 3G network being handled by a messaging centre (SMSC/MR) 30. In the instance shown, the message containing the delivery report message is called a Forward_SM message which conforms to GSM MAP standards. In this case it is a Mobile Terminated (MT) message sent to the originating party (A) and is indicated generally by the reference numeral 34, and has been modified with attached content. In the embodiment shown, the delivery report message is a status report. In an alternative embodiment of the invention, so as to avoid problems with wireless devices from certain vendors, the standard format Forward_SM message is sent with the standard Status Report but with modified content data appended in a second attached message. More particularly, the initial message (Forward_SM) may be a Mobile Originated message, sent from the originating MSC. The message is acknowledged and then the SMSC seeks to get the routing info (location) for the B party, by querying the HLR for that subscriber (SRI_SM Send Routing Info for SM) for B. The HLR replies with the MSC number where B is currently contactable (if B is contactable at all). If B is not contactable it is possible that a reply comprising a number of error conditions, including “Absent Subscriber” etc,, may be received. Once the SMSC knows the MSC number it attempts to forward the SMS (a Mobile Terminated message in this case). If this is acknowledged, then the delivery receipt can be sent to the originating subscriber (A), if one was requested. The first step is to get the location of the originating subscriber. This would be known at the time of receiving the MO, but the received message could have been stored for an undefined period, if B was absent initially, so that initial location of A could be out of date and has to be checked by querying the HLR. The final sequence shows the delivery of the prepared report to A and its acknowledgement.

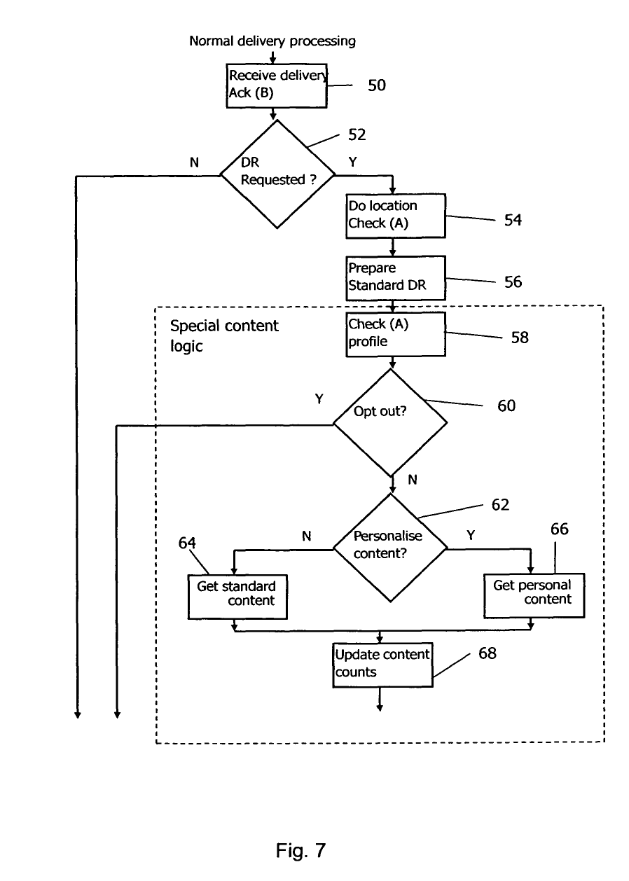

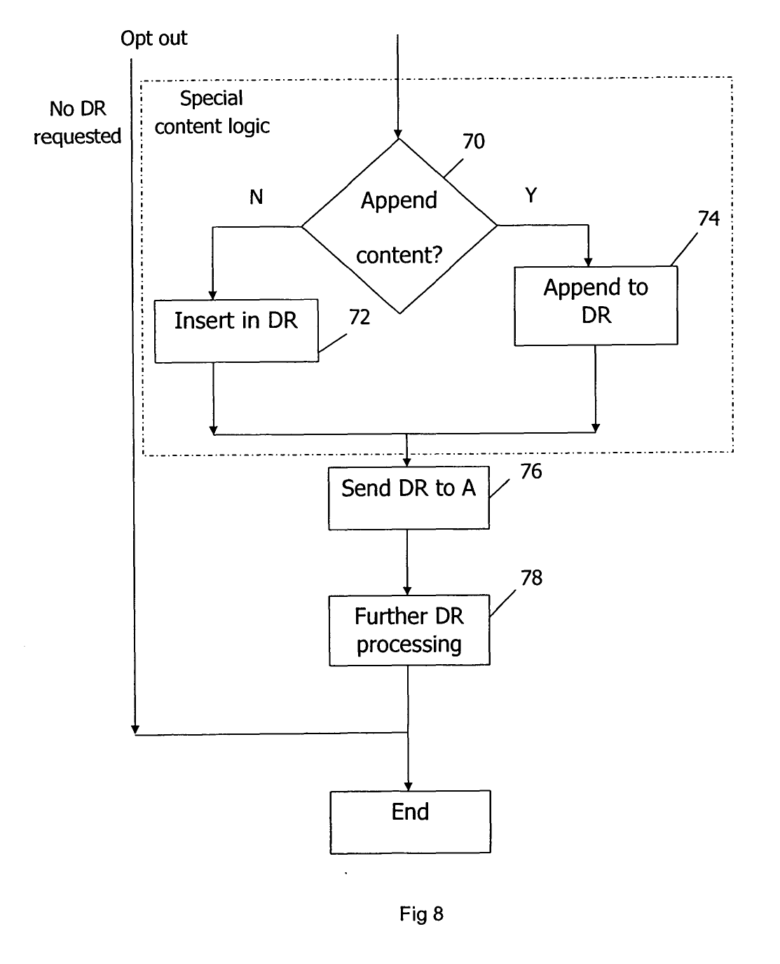

FIGS. 7 and 8 together show a flow diagram illustrating the steps in a method performed according to the present invention. At step 50, the messaging centre receives a delivery acknowledgment from a destination device (that is, the device receiving the message sent by the originator device). At step 52, a determination is made by the messaging centre as to whether a delivery report message has been requested by the originator device or subscriber. If no delivery report has been requested, the process ends. Alternatively, if a delivery report message has been requested then, at step 54, the messaging centre obtains location information for the originator device, and at step 56, prepares a standard delivery report message. At step 58, and once the basic report message has been prepared, the messaging centre via the special content processing logic, checks the profile of the subscriber to determine whether the subscriber has “Opted In or Out” of receiving additional content with the message report. At step 60, if the subscriber has opted not to receive content, by either an “opt out” or “opt in” mechanism, the flow returns to the standard processing and the process ends with the standard delivery report message being sent to the subscriber. Alternatively, if the subscriber has opted to receive content, then the content processing logic continues and at step 62, a determination regarding the content to be retrieved is made. Such a determination may be comprised in the profile of the subscriber and either standard content is retrieved from the content server or content store at step 64, or alternatively personalised content is retrieved at step 66. Content counts are updated at step 68, following which the content is included with the delivery report message at step 70. More specifically, the retrieved content is either inserted or embedded in the delivery report message at step 72, or alternatively, at step 74 it is appended to the delivery report message in a further data message. At step 76, the flow returns to the standard method and the delivery report message is transmitted to the subscriber with any further processing that may be required being carried out on the delivery report message at step 78.

It will be understood that the principle of the present invention have been described as they apply to SMS data messaging in a GSM or 3G network. The principles of the invention apply equally to MMS messaging in GSM or 3G networks and to both SMS and MMS messaging in CDMA wireless networks. The principles apply equally to the provision of data content in Delivery Report messages which are associated with other wireless data messaging formats, including but not limited to IMS, email, Instant Messaging and similar formats and protocols.

Aspects of the present invention have been described by way of example only and it should be appreciate that additions and/or modifications may be made thereto without departing from the scope thereof as defined in the appended claims.

1: A method of transmitting content to a subscriber of telephony services provided by an operator, the method comprising the steps of:
a) sending a data message from a message originator device, wherein the data message is coupled with a request for a delivery report message:
b) generating a delivery report message;
c) retrieving content from a content service to be sent to the subscriber as retrieved content; and
d) transmitting the retrieved content with the delivery report message to the subscriber.

2: The method of claim 1, wherein the retrieved content is transmitted with the delivery report message only upon request by the subscriber that the delivery report message be sent to the subscriber.

3: The method of claim 1 further comprising a step of:
e) embedding the retrieved content in the delivery report message for transmission to the subscriber.

4: The method of claim 1 further comprising a step of:
f) generating a further data message, wherein the retrieved content is embedded in the further data message for transmission to the subscriber at substantially the same time as the delivery report message.

5: The method of claim 4, wherein the further data message is displayed on a display screen of a subscriber device and is not stored in a memory of the subscriber device.

6: The method of claim 4, wherein the further data message and the delivery report message are transmitted in one or more messaging formats that includes short message service (SMS), multi-media message service (MMS), electronic mail (e-mail) and instant message format.

7: The method of claim 4, wherein the data message, the further data message, and the delivery report message are transmitted via a wireless cellular network, the wireless cellular network including a GSM network; a 3G or 4G network, and a CDMA network.

8: The method of claim 1, further comprising a step of:
g) retrieving the content from a storage means coupled locally with a messaging center.

9: The method of claim 1 further comprising a step of:
h) retrieving the content from one or more content servers connected remotely to a messaging center.

10: The method of clam further comprising a step of:
i) retrieving the content from a content queue for the subscriber.

11: The method of claim 1 further comprising a step of:
j) personalizing the retrieved content prior to transmission with the delivery report message.

12: The method of claim 1 further comprising a step of:
k) personalizing the retrieved content according to one or more subscriber parameters that include a location of the subscriber in a telecommunications network, spend attributes of the subscriber and preferences set by the subscriber and the operator.

13: The method of claim 12 further comprising a step of:
l) storing subscriber preferences locally in a messaging center.

14: The method of claim 1 further comprising a step of:
m) determining whether the subscriber has opted in or opted out of receiving the content with the delivery report message.

15: The method of claim 1 further comprising a step of:
n) time-stamping the retrieved content sent with the report message according to when the delivery report message is sent.

16: The method of claim 1, wherein in which the retrieved content sent with the delivery report message includes one or more messages that include advertising and/or sponsorship information.

17: The method of claim 1 further comprising a step of:
o) rotating the advertising and/or sponsorship information through a sequence so that the advertising and/or sponsorship information sent to the subscriber with two or more consecutive delivery report messages is not the same.

18: The method of claim 1, wherein the retrieved content sent with the report message includes one or more interactive links selectable by the subscriber to trigger transmission of interactive content to the subscriber.

19: The method of claim 1, wherein the content is provided by receiving standard delivery reports from an otherwise unmodified messaging center and amending the contents of the delivery report actually sent to the subscriber by inserting or appending the retrieved content and modifying other fields of the message.

21-37. (canceled)

38: The method of claim 12 further comprising the step of:
p) storing subscriber preferences locally in one or more subscriber profile servers connected remotely to a messaging center.

39: A system for transmitting content to a subscriber of telephony services provided by an operator, the system comprising:
means for sending a data message from a message originator device, the data message coupled with a request for a delivery report message;
means for generating the delivery report message;
means for retrieving content to be sent to the subscriber as retrieved content; and
means for transmitting the retrieved content with the delivery report message to the subscriber.
